(19) United States
(12) Patent Application Publication
(10) Pub. No.: US 2022/0165512 A1
(43) Pub. Date: May 26, 2022

(54) ELECTRODE FOR CAPACITORS, METHOD FOR PRODUCING SAME, AND CAPACITOR

(71) Applicant: Panasonic Intellectual Property Management Co., Ltd., Osaka (JP)

(72) Inventors: Kenichi EZAKI, Osaka (JP); Chiho NOBUMORI, Hyogo (JP); Takahiro YOSHINO, Osaka (JP); Hitoshi ISHIMOTO, Hyogo (JP)

(21) Appl. No.: 17/598,781

(22) PCT Filed: Mar. 19, 2020
(86) PCT No.: PCT/JP2020/012434

§ 371 Date: Sep. 27, 2021

(30) Foreign Application Priority Data
Mar. 27, 2019 (JP) 2019-061312
Mar. 27, 2019 (JP) 2019-061313

(51) Int. Cl. H01G 11/40; H01G 11/86; H01G 11/44

(52) U.S. Cl. CPC H01G 11/40; H01G 11/44; H01G 11/86

(57) ABSTRACT

A capacitor electrode including a first carbon, and at least one of a second carbon and a metal porous body. The first carbon includes a graphene, and the second carbon includes short carbon fibers having an average length of 10 μm or less and/or carbon particles having an average diameter of 0.1 μm or less. The graphene is layered via the second carbon.

### TECHNICAL FIELD

The present invention relates to a capacitor electrode, a method for producing the same, and a capacitor.

### BACKGROUND ART

Graphenes, whose theoretical specific surface area is about 2600 m²/g and that have electrical conductivity, are promising as materials for a capacitor electrode. However, unless the distance between graphene sheets is controlled appropriately, the overlapping of flat graphene sheets increases, failing to fully utilize the surface area of the graphenes.

Patent Literature 1 discloses a graphene sheet-integrated film including a plurality of graphene sheet stacks each including two or more graphene sheets stacked via a first carbon nanotube. The graphene stacks are electrically and mechanically connected to each other three-dimensionally via a second carbon nanotube. The literature suggests using a single-layer carbon nanotube having a length of 5 to 20 μm, as the first and second carbon nanotubes.

Patent Literature 2 suggests using, in a capacitor, an electrode which is a composite of nano-scale graphene platelets and a conductive biner, and reports that this can achieve a capacitance of 82 F/g.

Patent Literature 3 discloses an electrode for a power storage device including: a carbon nanotube, a graphene, an ionic liquid, and a three-dimensional network metal porous body that holds them in its pores. The ratio of the total amount of the carbon nanotube and the graphene to the amount of the ionic liquid is 10 mass % or more and 90 mass % or less, and the ratio between the carbon nanotube and the graphene is in the range of 3:7 to 7:3 by mass.

### CITATION LIST

### Patent Literature

[PTL 1] International publication No. WO 2012/073998
[PTL 2] The U.S. Pat. No. 7,623,340

### [PTL 3] Japanese Laid-Open Patent Publication No. 2014-225508

### SUMMARY OF INVENTION

### Technical Problem

When using a typical carbon nanotube (CNT), the CNT basal plane present between graphene sheets inhibits ion diffusion between graphene sheets, and therefore, the resistance tends to increase at low temperatures.

Moreover, in order to effectively utilize the surface area of the graphene, it is necessary to appropriately control the distance between graphene sheets, thereby to reduce the overlapping of graphene sheets. However, the graphene has a flat shape and tends to overlap with each other during the production process of an electrode. Therefore, it has been difficult to appropriately control the distance between graphene sheets, and a sufficiently high capacitance has not been achieved.

Furthermore, during charge and discharge of graphene, ions are intercalated and deintercalated between graphene sheet layers, and the deterioration of the current collecting channels due to expansion and contraction tends to be severe. As in Patent Literature 3, reinforcing the current collecting channels by using a metal porous body and a carbon nanotube (CNT) may be one possible solution. However, the internal structure of the electrode tends to be uneven, and stable production has been difficult.

### Solution to Problem

One aspect of the present invention relates to a capacitor electrode, including: a first carbon; and at least one of a second carbon other than the first carbon, and a metal porous body, wherein the first carbon includes a graphene, the second carbon includes short carbon fibers having an average length of 10 μm or less and/or carbon particles having an average diameter of 0.1 μm or less, and the graphene is layered via the second carbon.

Another aspect of the present invention relates to a capacitor, including the above-described capacitor electrode.

Yet another aspect of the present invention relates to a method for producing a capacitor electrode, the method including steps of: preparing an aqueous dispersion containing a first carbon raw material and a second carbon, the first carbon raw material being a graphene oxide; and reducing the graphene oxide in the aqueous dispersion, wherein the second carbon includes short carbon fibers having an average length of 10 μm or less and/or carbon particles having an average diameter of 0.1 μm or less.

Still another aspect of the present invention relates to a method for producing a capacitor electrode, the method including steps of: preparing an aqueous dispersion containing a first carbon raw material being a graphene oxide; and impregnating the aqueous dispersion into a metal porous body, to reduce the graphene oxide within voids of the metal porous body.

### Advantageous Effects of Invention

According to the present invention, a capacitor electrode having a high capacitance and exhibiting a low resistance even at low temperatures can be obtained using graphenes. According to the present invention, a capacitor electrode having a high capacitance can be obtained stably using graphenes.

### BRIEF DESCRIPTION OF DRAWINGS

FIG. 1 A partially-cutaway oblique view of an electric double-layer capacitor according to the present invention.

FIG. 2A A transmission electron microscope (TEM) photograph of a xerogel obtained in Example 1.

FIG. 2B A partially enlarged TEM photograph of FIG. 2A.

FIG. 3 A scanning electron microscope (SEM) photograph of a highly crystalline graphene used in Comparative Example 3.

FIG. 4 A scanning electron microscope photograph (SEM image) (a) and a transmission electron microscope photograph (TEM image) (b) of a composite of a metal porous body and a xerogel obtained in Example 2.

FIG. 5 An X-ray diffraction profile of the composite of a metal porous body and a xerogel obtained in Example 2.

FIG. 6 An X-ray diffraction profile of a highly crystalline graphene used in Comparative Examples 3 and 6.

### DESCRIPTION OF EMBODIMENTS

### First Embodiment

A capacitor electrode according to the present embodiment includes a first carbon and a second carbon other than the first carbon. The first carbon includes a graphene, and the second carbon includes short carbon fibers having an average length of 10 μm or less and/or carbon particles having an average diameter of 0.1 μm or less. The graphene is layered via the second carbon. Therefore, the ion diffusivity between graphene particles is greatly improved, and a capacitor electrode with low resistance can be obtained. Furthermore, since the second carbon is present between graphene particles, the overlapping between graphene sheets can be reduced, and the surface area of the graphene can be more effectively utilized. On the other hand, when the second carbon includes short carbon fibers and/or carbon particles, unlike when using a typical CNT, the ion diffusion in the graphene is not inhibited. Therefore, according to the present embodiment, a capacitor electrode having a high capacitance and exhibiting a low resistance even at low temperatures can be obtained using a graphene.

Here, the graphene is a carbon material whose minimum unit is a graphene sheet of one carbon atom thick, and in which, usually, a plurality of graphene sheets are stacked in layers, forming a stack. The graphene sheet is a one-carbon-atom-thick organization or a molecule composed of sp²-bonded carbons and has a honeycomb-like lattice structure spreading like a sheet. A typical graphene usually has a flat sheet form. Here, however, a variety of forms of graphene-sheet stacks having a disorder in the layer structure (or a disorder in the interlayer distance) are also included within the category of the graphene. The graphene may partially encompass a graphene analog, such as a graphene oxide. In the following, the graphene is sometimes referred to as a graphene sheet stack.

The capacitor electrode includes, for example, a metal current collector and an electrode layer supported on the current collector, and the first carbon and the second carbon are included as an active material that adsorbs and desorbs ions, in the electrode layer.

### (a) First Carbon

The graphene may have a microscopic three-dimensional structure (i.e., microtine structure). By having a three-dimensional structure, the overlapping between graphene sheets can be remarkably suppressed, and the surface area of the graphene can be further effectively utilized. The graphene sheet stack having a three-dimensional structure has a plurality of raised and recessed portions on its principal surface. With such a three-dimensional structure, the distance between graphene sheets can be appropriately controlled, and the overlapping between graphene sheets can be effectively reduced.

The average number of stacked layers in the graphene sheet stack in the graphene is, for example, 10 layers or less, and may be 5 layers or less. The closer to a single-carbon-atom thick graphene sheet (i.e., single layer sheet) being a minimum unit the graphene is, the more desirable it is. The average number of stacked layers may be the number of layers estimated from an interplanar distance of 002 planes (d002) calculated from a diffraction peak attributed to 002 plane in an X-ray diffraction profile (e.g., 2015 Autumn Meeting of Japanese Physical Society, Summary p. 1014). Alternatively, it may be a value estimated from an electron microscope (SEM etc.) photograph of the graphene. For example, from the scale of the SEM photograph of the graphene and the interplanar distance of 002 planes of the graphene (hereinafter sometime referred to as basal planes), the number of stacked layers of graphene sheets can be estimated. For example, the average number of stacked layers can be determined by selecting 20 graphene sheet stacks at random, to estimate the number of stacked layers in each stack, and averaging 10 numerical values in the middle range, with the largest to the 5th largest numerical values and the smallest to the 5th smallest numerical values excluded.

The interlayer distance of graphene sheets (i.e., the basal interplanar distance) in the graphene may be varied randomly. A random variation in the interlayer distance means that the graphene is low in crystallinity. The greater the disorder in the layered structure of the graphene is, the more remarkable the variation in the interlayer distance is.

The graphene may have, for example, a curly structure or a folded structure, as the three-dimensional structure. In this case, the individual graphene sheet stack itself has a fine microporous structure. Therefore, the ion diffusion near the surface of the graphene becomes more favorable. The presence of a curly structure or a folded structure can be confirmed by an electron microscope (SEM, TEM, etc.) photograph of the graphene.

The curly structure refers to, for example, a structure having randomly formed pleat-like raised and recessed portions. The folded structure refers to a structure having a folded portion where a single graphene sheet stack is partially folded a plurality of times. The folded structure is included in the category of the curly structure. The height of the raised portions or the depth of the recessed portions in the folded portion may be greater than the thickness of the carbon portion of the graphene sheet stack having that structure, and may be equal to or more than twice the thickness of the carbon portion.

An X-ray diffraction profile of the first carbon usually has a diffraction peak P1 attributed to 002 plane. The larger the overlapping between graphene sheets is, and the higher the crystallinity of the graphene is, the sharper the diffraction peak P1 becomes.

On the other hand, when the graphene has a three-dimensional structure, the diffraction peak P1 becomes broad, and can be waveform-separated into a plurality of peaks. On the higher angle side than the diffraction peak P1 of the X-ray diffraction profile of the first carbon, a halo pattern attributed to amorphous phase may be observed.

An interplanar distance of 002 planes (d002) of the first carbon as calculated from the X-ray diffraction profile is, for example, 0.338 nm (3.38 Å) or more. The d002 can be calculated as an average determined by waveform-separating a diffraction peak observed around at 2θ=26.38°, to calculate a d002 value of each component, and averaging the values. The distance between 002 planes (d002) of the first carbon is preferably 0.340 nm (3.40 Å) or more, and in view of maintaining a large surface area of the graphene, more preferably 0.360 nm (3.60 Å) or more, further more preferably 0.370 nm (3.70 Å) or more.

### (b) Second Carbon

The second carbon may include short carbon fibers having an average length of 10 μm or less and/or carbon particles having an average diameter of 0.1 μm or less.

### (i) Short Carbon Fibers

The short carbon fibers may be, for example, vapor-growth carbon fibers, carbon nanotubes, carbon nanofibers, and the like. The short carbon fibers may have a hollow space (hollow portion) in its inside.

The average length of the short carbon fibers may be 10 μm or less, but in view of higher ion diffusivity between graphene particles, is desirably 2 μm or less, more desirably 0.1 μm or less. The average length of the short carbon fibers can be analyzed from an electron microscope (SEM, TEM, etc.) photograph. For example, the average length can be determined by selecting 20 short carbon fibers at random, to measure the length of each fiber, and averaging 10 numerical values in the middle range, with the largest to the 5th largest numerical values and the smallest to the 5th smallest numerical values excluded. Since the short carbon fibers are as short as 10 μm or less, the shape of the short carbon fiber can be approximated to an almost straight line shape. Therefore, the length of each short carbon fiber means the length of a straight line connecting both ends of the short carbon fiber.

The average diameter of the short carbon fibers is, for example, 200 nm or less, may be 5 nm or more and 200 nm or less, and may be 10 nm or more and 170 nm or less. The diameter of each short carbon fiber is a maximum length in the direction perpendicular to the longitudinal direction of the short carbon fiber, and the average diameter can be analyzed from an electron microscope (SEM, TEM, etc.) photograph. For example, the average diameter can be determined by selecting 20 short carbon fibers at random, to measure the diameter of each fiber, and averaging 10 numerical values in the middle range, with the largest to the 5th largest numerical values and the smallest to the 5th smallest numerical values excluded.

### (ii) Carbon Particles

The average diameter of the carbon particles may be 0.1 μm or less, but in view of higher ion diffusivity between graphene particles, is desirably 0.05 μm or less, more desirably 0.03 μm or less. The average diameter of the carbon particles can be analyzed from an electron microscope (SEM, TEM, etc.) photograph. For example, the average diameter can be determined by selecting 20 carbon particles at random, to measure the maximum diameter of each particle, and averaging 10 numerical values in the middle range, with the largest to the 5th largest numerical values and the smallest to the 5th smallest numerical values excluded. Further, when the carbon particles are separable, a laser diffraction-type particle size distribution analyzer can be used for measurement. In this case, the median diameter at a cumulative volume 50% in a volumetric particle size distribution can be determined as the average diameter.

Examples of the carbon particles include graphite, non-graphitizable carbon, graphitizable carbon, and carbon black. Preferred is carbon black, which is exemplified by acetylene black, Ketjen Black, thermal black, furnace black, channel black, and the like. Note that a plurality of carbon particles (here, primary particles) may be connected each other, forming a chain structure (secondary particle). In this case, the average diameter is an average diameter of the primary particles. The length of the chain structure is not limited, but is desirably 2 μm or less, more desirably 0.5 μm or less, and further more desirably 0.05 μm or less.

(iii) First Carbon/Second Carbon Ratio

The ratio of the first carbon to the total of the first carbon and the second carbon may be 40 to 98 mass %, and may be 80 to 98 mass %. In order to obtain a high-capacitance capacitor electrode, it is desirable that the ratio of graphene having a large surface area is high. On the other hand, when the ratio of the first carbon is too high, the second carbon present between graphene particles is reduced, and the overlapping of graphene sheets is difficult to be effectively suppressed. When the ratio of the first carbon is within the above range, the overlapping of graphene sheets can be significantly suppressed, and the capacitance of the capacitor electrode can be efficiently increased.

### (c) Third Component

The electrode layer may include, in addition to the first carbon and the second carbon, another active material, such as an activated carbon. The present invention does not exclude the case where the electrode layer contains a CNT whose average length exceeds 10 μm. A small amount of CNT may be contained in the electrode layer.

### (d) Binder

The capacitor electrode may include a binder. When forming a mixture of the first carbon and the second carbon into a sheet- or film-like electrode layer, the binder serves to assist the bonding of the first carbon with each other, the bonding of the second carbon with each other, or the bonding of the first carbon with the second carbon. The binder also serves to assist the bonding of the electrode layer with the current collector.

Examples of the binder include a fluorocarbon resin, such as polytetrafluoroethylene (PTFE), polyvinylidene fluoride (PVdF), and vinylidene fluoride-hexafluoropropylene copolymer (PVdF-HFP), a water-soluble resin, such as carboxymethyl cellulose (CMC), polyethylene oxide (PEO), polyethylene glycol (PEG), polyacrylonitrile (PAN), polymethyl methacrylate (PMMA), polyvinyl alcohol (PVA), polyvinyl pyrrolidone (PVP), polyacrylic acid (PAA), and polyvinyl acetate.

### (e) Current Collector

A metal foil, a metal porous body or the like may be used as a current collector. The material of the current collector may be aluminum, copper, nickel, iron, stainless, platinum, and the like. The material may be an alloy containing the above metal as a main component. The metal foil may be a plane foil, but may be, for example, a surface-roughened foil obtained by etching or the like, or a plasma-treated foil. The metal porous body has, for example, a three-dimensional network structure.

The mass per unit area of the metal porous body is, for example, 500 g/m² or less, and may be 150 g/m² or less. The porosity in the metal porous body is, for example, 80 vol % to 98 vol %, and may be 90 vol % to 98 vol %.

The average pore diameter of the voids of the metal porous body is, for example, 50 μm or more and 1000 μm or less, may be 400 μm or more and 900 μm or less, and may be 450 μm or more and 850 μm or less.

A description will be given below of an example of a method for producing a capacitor electrode.

### (i) Dispersion Preparation Step

First, an aqueous dispersion containing a first carbon raw material and a second carbon is prepared. The first carbon raw material is a precursor of a first carbon. The first carbon raw material used here is a graphene oxide. The second carbon includes short carbon fibers having an average length of 10 μm or less and/or carbon particles having an average diameter of 0.1 μm or less.

The aqueous dispersion may contain a dispersant, such as carboxymethyl cellulose (CMC), and the like, in addition to the first carbon raw material, the second carbon and water.

The graphene oxide is a graphene analog having an oxygen-containing functional group, which is, for example, a material that is produced by exfoliation, in a single-layer or multi-layer form, from graphite through oxidation of the graphite. The oxygen-containing functional group is a hydrophilic group, such as a hydroxyl group, a carbonyl group, or a carboxyl group, and has a water dispersible property.

The oxidation of graphite can be carried out, for example, in water using an oxidizing agent. Examples of the oxidizing agent include sulfuric acid, potassium permanganate, chromic acid, sodium dichromate, sodium nitrate, peroxide, persulfate, and organic acid peroxide. A water-soluble solvent may be added to the water. Examples of the water-soluble solvent include alcohols, ketones such as acetone, and ethers such as dioxane and tetrahydrofuran. The oxidation reaction in water produces an aqueous dispersion of graphene oxide. By adding a second carbon to the aqueous dispersion of graphene oxide, an aqueous dispersion containing the first carbon raw material and the second carbon can be obtained.

The degree of oxidation (oxygen content) of the graphene oxide is, for example, 10 to 60 mass %, may be 20 to 50 mass %, and may be 30 to 50 mass %. The degree of oxidation of the graphene oxide can be measured, for example, by X-ray photoelectron spectroscopy (XPS). Specifically, it can be determined by measuring the masses of carbon (C) and oxygen (O) contained in the graphene oxide by XPS, to calculate a ratio of the mass of oxygen to the total mass of carbon and oxygen.

### (ii) Reduction Step

Next, the graphene oxide is reduced in the aqueous dispersion containing the graphene oxide (first carbon raw material) and the second carbon, that is, in the presence of the second carbon. The reduction method is not limited, and for example, a hydrothermal treatment may be employed. For example, the aqueous dispersion is sealed in an autoclave and treated hydrothermally, so that a gel-form product can produced. The temperature for the hydrothermal treatment may be, for example, 150° C. or higher or preferably 170° C. or higher and 200° C. or lower.

The hydrothermal treatment can produce a crosslinked structure of the first carbon and the second carbon. For example, the first carbon and the second carbon are crosslinked via a functional group, such as an ether linking group (—O—). By performing such a hydrothermal treatment, a gel-form product which is formed into a composite with the second carbon and contains a graphene having a three-dimensional structure can be obtained.

To allow the reduction to further proceed, the gel-form product may be brought into contact with a reducing agent. Examples of the reducing agent include metal hydrides, borohydrides, boranes, hydrazines or hydrazides, ascorbic acids, thioglycolic acids, cysteines, sulfurous acids, thiosulfuric acids, and dithionous acids. For example, the gel-form product may be immersed in an aqueous solution containing a water-soluble reducing agent, such as sodium ascorbate. The temperature of the aqueous solution is, for example, 20 to 110° C., may be 40 to 100° C., and may be 50 to 100° C. The amount of the reducing agent used may be adjusted as appropriate, depending on its kind, the degree of oxidation of the graphene oxide, the amount of the gel-form product, and others. The degree of oxidation of the graphene after reduction may be, for example, 40 mass % or less, and may be 20 mass % or less.

(iii) Freeze-Drying Step

The gel-form product is then preferably freeze-dried. By performing freeze-drying, a dry gel (xerogel) in which the three-dimensional structure of the graphene is well maintained can be obtained. The freeze drying is performed, for example, at −50° C. to 0° C., preferably −50° C. to −20° C., under a reduced pressure of, for example, 100 Pa or less, or 1 Pa or less.

The xerogel is a composite of the graphene having a three-dimensional structure and the second carbon. The composite includes a graphene having a three-dimensional structure that is layered via the second carbon between them. The composite is used as an active material for a capacitor electrode that develops a high capacitance.

### (iv) Electrode Formation Step

Next, the composite of the first carbon and the second carbona is dispersed, together with a binder, in a dispersion medium, such as water, to prepare a slurry. When the second carbon is present between graphene particles, rearrangement of graphene sheets is unlikely to occur even in the slurry, and further occurrence of overlapping of graphene sheets can be suppressed. In the composite obtained through hydrothermal treatment, the first carbon and the second carbon are usually crosslinked via a functional group, by which free movement of graphene particles is restricted. Therefore, the three-dimensional structure tends to be maintained even in the slurry.

By applying the obtained slurry onto a current collector, and drying the applied film, an electrode layer supported on the current collector can be formed, and thus, a capacitor electrode can be obtained. Thereafter, the electrode layer may be rolled.

Next, a description will be given below of an example of a capacitor including the above-described capacitor electrode. The above-described capacitor electrode is applicable as an electrode, for example, for an electric double-layer capacitor, a lithium ion capacitor, and other capacitors.

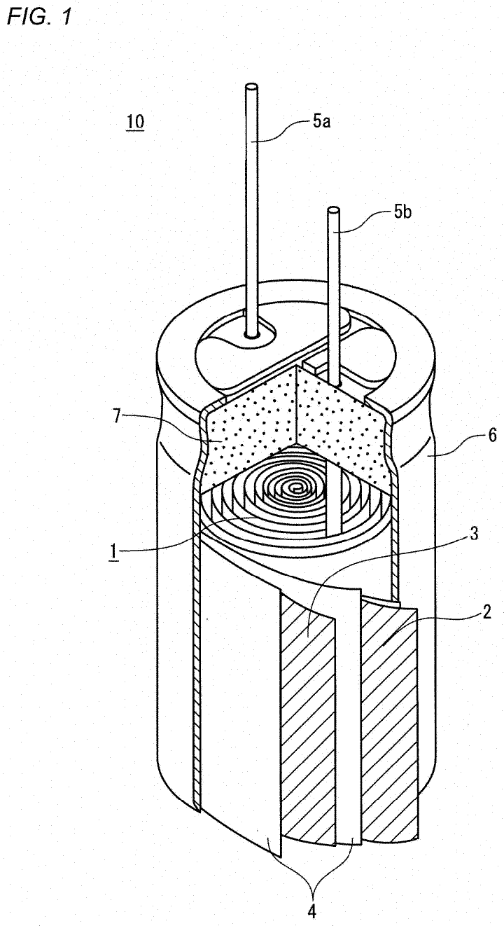

FIG. 1 is a partially-cutaway oblique view of an electric double-layer capacitor 10.

The electric double-layer capacitor 10 of the illustrated example includes a wound capacitor element 1. The capacitor element 1 is configured by winding a first electrode 2 and a second electrode 3 each in a sheet form, with a separator 4 interposed therebetween. The first electrode 2 and the second electrode 3 respectively have a first current collector and a second current collector each made of a metal, with a first electrode layer and a second electrode layer respectively supported thereon, and develop a capacitance by adsorbing and desorbing ions. The first and second current collectors may be, for example, an aluminum foil. The current collectors may have a surface roughened by etching or other techniques. The separator 4 may be, for example, a nonwoven fabric mainly composed of cellulose. To the first and second electrodes 2 and 3, lead wires 5a and 5b are connected, respectively, as a current leading member. The capacitor element 1 is housed, together with an electrolyte (not shown), in a cylindrical outer case 6. The outer case 6 may be made of, for example, a metal, such as aluminum, stainless steel, copper, iron and brass. The opening of the outer case 6 is sealed with a sealing member 7. The lead wires 5a and 5b are extended outside so as to pass through the sealing member 7. The sealing member 7 may be, for example, a rubber material, such as butyl rubber.

The electrode layer contains an active material as an essential component, and may further optionally contain a binder, a conductive additive, and the like. The active material includes the first carbon and the second carbon having the characteristics as already described. The electrode layer can be obtained by preparing a slurry by kneading the active material, a binder (e.g., carboxymethyl cellulose (CMC)) and the like, together with water, and applying the slurry onto a surface of a current collector, followed by drying and rolling the applied film.

The electrolyte is a mixture of a solvent and an ionic substance (e.g., organic salt) dissolved in the solvent. The solvent may be a non-aqueous solvent or an ionic liquid. The concentration of the ionic substance in the electrolyte is, for example, 0.5 to 2.0 mol/L.

The non-aqueous solvent is preferably a high boiling point solvent. Examples thereof include: lactones, such as γ-butyrolactone; carbonates, such as propylene carbonate; polyvalent alcohols, such as ethylene glycol and propylene glycol; cyclic sulfones, such as sulfolane; amides, such as N-methylacetamide, N,N-dimethylformamide, and N-methyl-2-pyrrolidone; esters, such as methyl acetate; ethers, such as 1,4-dioxane; ketones, such as methyl ethyl ketone; and formaldehyde.

The organic salt is a salt in which at least one of the anion and the cation contains an organic material. Examples of the organic salt in which the cation contains an organic material include a quaternary ammonium salt. Examples of the organic salt in which the anion (or both ions) contains an organic material include trimethylamine maleate, triethylamine borodisalicylate, ethyldimethylamine phthalate, mono 1,2,3,4-tetramethylimidazolinium phthalate, and mono 1,3-dimethyl-2-ethylimidazolinium phthalate.

In view of improving the withstand voltage characteristics, the anion preferably contains a fluorine atom, which is exemplified by BF₄⁻ and/or PF₆⁻. Preferred examples of the organic salt include a tetraalkylammonium salt, such as ethyltrimethylammonium tetrafluoroborate.

### Second Embodiment

A capacitor electrode according to the present embodiment includes a metal porous body and a first carbon filled in the voids of the metal porous body. The first carbon includes a graphene, and the graphene has a three-dimensional structure. In other words, the capacitor electrode has a metal porous body as a current collector, and a graphene having a three-dimensional structure is supported as an active material by the metal porous body.

Since the first carbon having a three-dimensional structure is filled in the voids of the metal porous body, the current collecting property of the electrode is unlikely to deteriorate, and the deterioration in capacitance can be suppressed. The three-dimensional structure (i.e., a microstructure) of the graphene is more microscopic than that of the metal porous body. The microscopic three-dimensional structure can effectively reduce the overlapping of graphene sheets. Furthermore, the first carbon having a three-dimensional structure becomes bonded to the skeleton of the metal porous body. This is also effective in maintaining the microstructure of the first carbon. Therefore, according to the present embodiment, a high-capacitance capacitor electrode can be obtained stably, using a graphene.

Here, the graphene is a carbon material as defined in the first embodiment, and the description of the graphene given in the first embodiment applies similarly in the present embodiment.

### (a) Metal Porous Body

The metal porous body may be, for example, a sponge metal, an etched foil, a sintered body of metal particles, or the like, but is desirably a metal porous body having a three-dimensional network structure. The three-dimensional network structure is, for example, a structure in which fibrous or rod-like moieties formed of a metal are three-dimensionally linked to form a network-like skeleton. The skeleton may be a hollow structure having an empty space therein. The metal porous body having a three-dimensional network structure can be produced by, for example, applying a metal plating on a resin porous body having continuous voids, and then removing the resin porous body. In this case, the three-dimensional network structure has voids communicating with one another (i.e., communicating pores).

The mass per unit area of the metal porous body is, for example, 500 g/m² or less, and may be 150 g/m² or less. The porosity in the metal porous body is, for example, 80 vol % to 98 vol %, and may be 90 vol % to 98 vol %. The average pore diameter of the voids of the metal porous body is, for example, 50 μm or more and 1000 μm or less, may be 400 μm or more and 900 μm or less, and may be 450 μm or more and 850 μm or less.

The material of the metal porous body may be aluminum, copper, nickel, iron, stainless, platinum, and the like. The material may be an alloy containing the above metal as a main component.

### (b) First Carbon

The graphene or the graphene sheet stack has a microscopic three-dimensional structure, as described in the first embodiment. Since the graphene sheet stack has a three-dimensional structure, the overlapping of graphene sheets can be remarkably suppressed. Also, since the graphene sheet stack becomes bonded to the metal porous body, the microstructure of the graphene sheet stack can be maintained. Thus, the surface area of the graphene can be effectively utilized. Here, the graphene sheet stack having a three-dimensional structure has on its principal surface a plurality of raised and recessed portions. By such a three-dimensional structure, the distance between graphene sheets can be controlled appropriately, and the overlapping of graphene sheets can be effectively suppressed. The graphene sheet stack may have, for example, a curly structure or a folded structure, as the three-dimensional structure.

### (c) Second Carbon

The capacitor electrode may further include a second carbon filled in the voids of the metal porous body. The second carbon includes short carbon fibers having an average length of 10 μm or less and/or carbon particles having an average diameter of 0.1 μm or less, and the description of the second carbon given in the first embodiment also applies similarly in the present embodiment.

Since the second carbon includes short carbon fibers and/or carbon particles, it can be easily filled into the voids of the metal porous body, which makes stable electrode production possible. Therefore, the internal structure of the electrode is unlikely to be heterogeneous. When a typical CNT is present between graphene sheet stacks, the ion diffusion tends to be inhibited, which often leads to an increase in resistance at low temperatures. However, when using short carbon fibers and/or carbon particles, such an increase in resistance is unlikely to occur.

When the capacitor electrode includes the second carbon in addition to the first carbon, the graphene is preferably layered via the second carbon. This can further suppress the overlapping of graphene sheets. Thus, the surface area of the graphene can be utilized more effectively.

First Carbon/Second Carbon Ratio

The ratio of the first carbon to the total of the first carbon and the second carbon may be controlled similarly to in the first embodiment.

### (d) Third Component

The electrode layer may include, in addition to the first carbon and the second carbon, another active material, such as activated carbon. The present invention does not exclude the case where the electrode layer contains a CNT whose average length exceeds 2 μm. A small amount of CNT may be contained in the electrode layer.

Next, a description will be given of an exemplary method for producing a capacitor electrode.

### (i) Dispersion Preparation Step

First, an aqueous dispersion containing a graphene oxide serving as a first carbon raw material is prepared. The graphene oxide is a precursor of a first carbon. In the case of preparing an electrode containing a second carbon, in addition to the first carbon, the second carbon may be further mixed in the aqueous dispersion containing a graphene oxide. The graphene oxide is a material as defined in the first embodiment.

The aqueous dispersion may further contain, in addition to the first carbon raw material, the second carbon, and water, a dispersant, such as carboxymethyl cellulose (CMC), and others.

### (ii) Reduction Step

Next, the aqueous dispersion containing a graphene oxide is impregnated into a metal porous body, and then the graphene oxide is reduced within the voids of the metal porous body. The method of impregnating the aqueous dispersion into a metal porous body is not limited. For example, a metal porous body may be immersed in the aqueous dispersion, or the aqueous dispersion may be applied onto a metal porous body.

The method of reducing the graphene oxide is not limited, and exemplified by a hydrothermal treatment. For example, a metal porous body impregnated with the aqueous dispersion is sealed in an autoclave and treated hydrothermally, so that a gel-form product can be produced within the voids of the metal porous body. The temperature for the hydrothermal treatment may be, for example, 150° C. or higher, and is preferably 170° C. or higher and 200° C. or lower.

The hydrothermal treatment can produce a crosslinked structure of the metal porous body and the first carbon. For example, the metal porous body and the first carbon are crosslinked via a functional group, such as an ether linking group (—O—). By performing such a hydrothermal treatment, a gel-form product which is formed into a composite with the metal porous body and contains a graphene having a three-dimensional structure can be obtained.

When a second carbon is contained together with a graphene oxide in the aqueous dispersion, the graphene oxide is reduced in the presence of the second carbon. In this case, the hydrothermal treatment can also produce a crosslinked structure of the first carbon and the second carbon. For example, the first carbon and the second carbon are crosslinked via a functional group, such as an ether linking group. In other words, a gel-form product which is formed into a composite with the metal porous body and the second carbon and contains a graphene having a three-dimensional structure can be obtained.

To allow the reduction to further proceed, the gel-form product may be brought into contact with a reducing agent, under the similar conditions to those in the first embodiment.

(iii) Freeze-Drying Step

The gel-form product is then preferably freeze-dried, under the similar conditions to those in the first embodiment. By freeze-drying the gel-form product within the voids of the metal porous body, the connection between the metal porous body and the first carbon (and the second carbon) tends to be well maintained. This can suppress the deterioration of the current collecting channels even when the graphene expands and contracts repetitively during charge and discharge. A metal porous body-xerogel composite obtained by freeze-drying can be used as it is as a capacitor electrode that develops a high capacitance.

The above-described capacitor electrode is applicable as an electrode for a capacitor, such as an electric double-layer capacitor as illustrated in FIG. 1 and a lithium ion capacitor. Referring to FIG. 1, in the present embodiment, the first electrode 2 and the second electrode 3 are each a composite containing at least a first carbon (xerogel) and a metal porous body, and develop a capacitance as the first carbon adsorbs and desorbs ions. Other component elements of the present embodiment are similar to those of the first embodiment.

In the above embodiments, the description is given of a wound capacitor; however, the application of the present invention is not limited to the above, and the present invention is applicable to a capacitor having another structure, such as a laminated- or coin-type capacitor.

The present invention will be more specifically described below with reference to Examples, but the present invention is not limited to the Examples.

### EXAMPLE 1

In the present Example, a wound electric double-layer capacitor (Φ18 mm by L (length) 70 mm) having a rated voltage of 2.8 V was produced. A detailed description will be given below of the production method for the electric double-layer capacitor.

### (i) Preparation of Active Material

To an aqueous dispersion containing 0.35 mass % of a graphene oxide serving as a first carbon raw material, a carbon black (acetylene black available from Denka Company Limited (average diameter of primary particles: 35 nm)) serving as a second carbon was added, and mixed in a thin-film spin system high-speed mixer (FILMIX (registered tradename)) available from PRIMIX Corporation, to prepare an aqueous dispersion having a total content of the first carbon raw material and the second carbon of 0.39 mass %.

Next, the aqueous dispersion was subjected to a hydrothermal treatment at 180° C. for one hour, to give a gel-form product. Subsequently, the gel-form product was immersed in an aqueous sodium ascorbate solution (sodium ascorbate concentration: 1.0 mol/L) serving as a reducing agent, and heated to 100° C. and held for two hours, so that the graphene oxide was fully reduced. Then, the gel-form product was freeze-dried at −20° C. under a reduced pressure of 100 Pa, to give a xerogel.

Next, the xerogel (i.e., a composite of the first carbon and the second carbon) was dispersed in water, together with CMC serving a binder, to prepare a slurry. The CMC was used in an amount of 10 parts by mass per 100 parts by mass of the xerogel. The slurry was applied onto a 30-μm-thick current collector made of an Al foil, and the applied film was vacuum-dried at 110° C., and rolled, to form an electrode layer. A capacitor electrode was thus obtained.

A pair of the electrodes were prepared. A lead wire was connected to each electrode, and the electrodes were wound, with a nonwoven fabric separator made of cellulose interposed therebetween, to constitute a capacitor element. The capacitor element was housed together with an electrolyte in a predetermined outer case. The case was sealed with a sealing member, to complete an electric double-layer capacitor A1. The electrolyte used here was prepared by dissolving ethyldimethylimidazolium tetrafluoroborate at a concentration of 1.0 mol/L in propylene carbonate serving as a non-aqueous solvent. This was followed by an aging treatment performed at 60° C. for 16 hours under application of a rated voltage.

### Evaluation 1

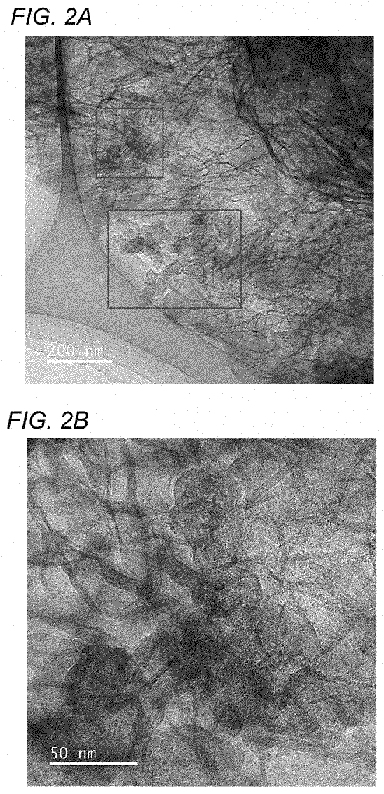

FIG. 2A is a TEM photograph of the xerogel used for preparing a slurry in the present Example. FIG. 2B is a partially enlarged TEM photograph of FIG. 2A. These photographs show a chain of connected primary particles of carbon black is present between layers in the graphene sheet stack.

A curly structure or a folded structure having a plurality of randomly-formed raised and recessed portions can be observed in the TEM image. The height of the raised portions or the depth of the recessed portions in the folded portion is sufficiently greater than the thickness of the carbon portion, and is at least twice the thickness of the carbon portion.

Furthermore, the xerogel was subjected to an X-ray diffraction measurement. As a result, a broad halo pattern attributed to amorphous phase was observed on the higher angle side than the diffraction peak P1 attributed to 002 plane, indicating the presence of the curly structure or the folded structure. The obtained X-ray diffraction profile was analyzed, to determine a d002 of the graphene. The d002 was about 0.34 nm or more.

Next, the electric double-layer capacitor A1 was measured for its capacitance at 25° C. and −30° C. Also, a ratio (C(−30/25)) of the capacitance at −30° C. to the capacitance at 25° C. was determined. The ion diffusion is rate-determined at low temperatures. Therefore, the higher the C(−30/25) ratio is, the lower the resistance to the ion diffusion is.

### Comparative Example 1

A xerogel was prepared in the same manner as in Example 1, except that the acetylene black serving as a second carbon was not used. An electric double-layer capacitor B1 was produced using the xerogel, and evaluated as above.

### Comparative Example 2

A xerogel was prepared in the same manner as in Example 1, except that the acetylene black serving as a second carbon was not used. An electric double-layer capacitor B2 was produced in the same manner as in Example 1 except that an acetylene black was added in an amount of 10 parts by mass per 100 parts by mass of the xerogel to the slurry, and evaluated as above.

### Comparative Example 3

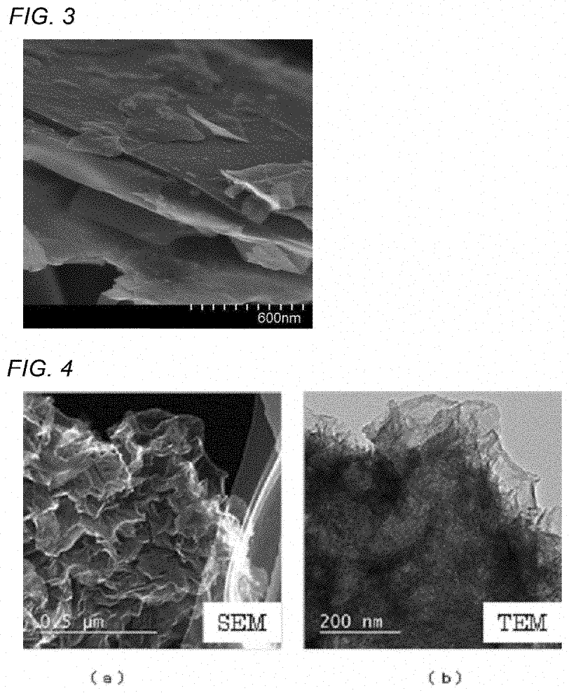

A slurry containing acetylene black was prepared in the same manner as in Comparative Example 2, except that a highly crystalline graphene was used in place of the xerogel. An electric double-layer capacitor B3 was produced in the same manner as in Example 1 except for using the slurry, and evaluated as above. An electron microscope (SEM) photograph of the highly crystalline graphene according to the present Comparative Example is shown in FIG. 3.

The evaluation results of the above Example 1 and Comparative Examples 1 to 3 are shown in Table 1.

TABLE 1

| | | Capac- | Capac- | |
|---|---|---|---|---|
| | | itance | itance | C(−30/ |
| Capac- | | (F/g) at | (F/g) at | 25) |
| itor | Active material | 25° C. | −30° C. | ratio |
| A1 | First carbon/Second carbon | 141.4 | 18.1 | 0.128 |
| | Hydrothermally treated | | | |
| B1 | Hydrothermally treated graphene | 70.3 | 6.8 | 0.097 |
| B2 | Hydrothermally treated graphene/ | 74.1 | 7.4 | 0.100 |
| | Second carbon Mixture | | | |
| B3 | Highly crystalline graphene/ | 45.1 | 4.2 | 0.093 |
| | Second carbon Mixture | | | |

Table 1 shows that the capacitor A1 has a capacitance significantly higher than those of B1 to B3, and the capacitor A1 is a low-resistance capacitor excellent in ion diffusivity even at low temperatures. In capacitors B1 and B2, their capacitances were significantly reduced as compared to that of the capacitor A1, and their capacitances were approximately equal to each other. This shows that even when a xerogel and an acetylene black is mixed at the time of preparing a slurry, it is difficult to form a structure advantageous for ion diffusion, i.e., a structure in which the graphene is layered via the acetylene black, and it is also difficult to maintain the three-dimensional structure of the graphene. On the other hand, in a xerogel obtained by reducing an aqueous dispersion of a graphene oxide and a second carbon (carbon black), followed by freeze-drying, the graphene can be formed so as to be layered via the acetylene black, and the three-dimensional structure of the graphene can be maintained. This is presumably because, for example, the first carbon and the second carbon become cross-linked with each other via a chemical linkage, such as an ether linkage.

### EXAMPLE 2

In the present Example, a wound electric double-layer capacitor (Φ18 mm by L (length) 70 mm) having a rated voltage of 2.8 V was produced. A detailed description will be given below of the production method for the electric double-layer capacitor.

An aqueous dispersion containing 0.35 mass % of a graphene oxide serving as a first carbon raw material was prepared. Separately, as a metal porous body having a three-dimensional network structure, an aluminum (Al) porous body having voids whose average pore diameter was 510 μm and having a thickness of 1 mm was prepared. The metal porous body was immersed in the aqueous dispersion, so that the voids were filled with the aqueous dispersion.

Next, the Al porous body impregnated with the aqueous dispersion was subjected to a hydrothermal treatment at 180° C. for one hour, to give a complex of the Al porous body and a gel-form product. Subsequently, the complex was immersed in an aqueous sodium ascorbate solution (sodium ascorbate concentration: 1.0 mol/L) serving as a reducing agent, and heated to 100° C. and held for two hours, so that the graphene oxide was fully reduced, and a graphene having a three-dimensional structure was produced. Then, the gel-form product was freeze-dried at −20° C. under a reduced pressure of 100 Pa, to give a capacitor electrode which was a complex of the Al porous body and the xerogel.

### Evaluation 2

### (Structure of First Carbon)

A scanning electron microscope photograph (SEM image) of the complex of the A1 porous body and the xerogel is shown in FIG. 4(a), and a transmission electron microscope photograph (TEM image) thereof is shown in FIG. 4(b). A curly structure or a folded structure having a plurality of randomly-formed raised and recessed portions can be observed in each image. The height of the raised portions or the depth of the recessed portions in the folded portion is sufficiently greater than the thickness of the carbon portion, and is at least twice the thickness of the carbon portion.

### (Capacitance)

A pair of the same electrodes were prepared. A lead wire was connected to each electrode, and the electrodes were wound, with a nonwoven fabric separator made of cellulose interposed therebetween, to constitute a capacitor element. The capacitor element was housed together with an electrolyte in a predetermined outer case. The case was sealed with a sealing member, to complete an electric double-layer capacitor A2. The electrolyte used here was prepared by dissolving ethyldimethylimidazolium tetrafluoroborate at a concentration of 1.0 mol/L in propylene carbonate serving as a non-aqueous solvent. This was followed by an aging treatment performed at 60° C. for 16 hours under application of a rated voltage. The electric double-layer capacitor A2 was measured for its capacitance at25° C.

(Interplanar Distance of 002 Planes (d002))

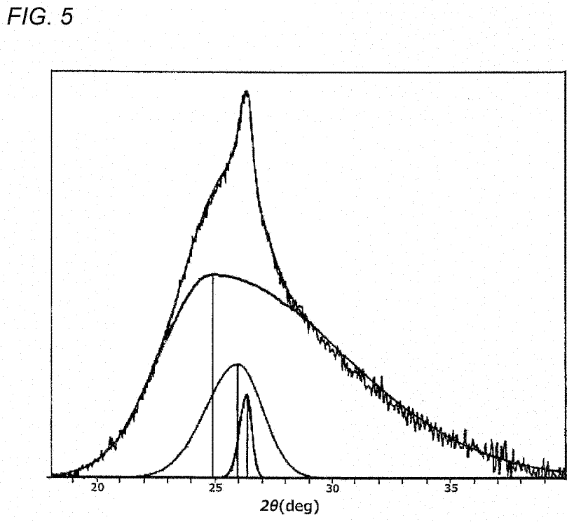

The electric double-layer capacitor was disassembled, and the graphene contained in the electrode was subjected to an X-ray diffraction measurement. The obtained X-ray diffraction profile was analyzed, to determine a d002 of the first carbon. The d002 was 3.422 Å. The X-ray diffraction profile of the composite of the metal porous body and the xerogel is shown in FIG. 5.

In FIG. 5, the diffraction peak P1 attributed to 002 plane is relatively broad, and can be waveform-separated into a plurality of peaks. This indicates that the interlayer distance between graphene sheets is randomly varied. Furthermore, a broad halo pattern attributed to amorphous phase can be observed on the higher angle side than the diffraction peak P1.

### Comparative Example 4

An aqueous dispersion containing 0.35 mass % of a graphene oxide serving as a first carbon raw material was prepared in the same manner as in Example 2, and the aqueous dispersion was subjected to a hydrothermal treatment at 180° C. for one hour, to give a gel-form product. Subsequently, the gel-form product was reduced in the same manner as in Example 2 in an aqueous sodium ascorbate solution serving as a reducing agent. The gel-form product was then freeze-dried at −20° C. under a reduced pressure of 100 Pa, to form a xerogel.

Next, the xerogel was dispersed in water, together with CMC serving a binder, to prepare a slurry. The CMC was used in an amount of 10 parts by mass per 100 parts by mass of the xerogel. The slurry was packed into a metal porous body as used in Example 2, and heated and dried at 110° C. under vacuum, and thus, a capacitor electrode in which the graphene content was substantially the same as in Example 2 was obtained. An electric double-layer capacitor B4 was produced in the same manner as in Example 2, except for using the electrode thus obtained, and evaluated as above.

### Comparative Example 5

A slurry was prepared in the same manner as in Comparative Example 4, except that an activated carbon (specific surface area: 2200 m²/g) was used in place of the xerogel. An electric double-layer capacitor B5 was produced in the same manner as in Comparative Example 4 except for using the slurry, and evaluated as above.

### Comparative Example 6

A slurry was prepared in the same manner as in Comparative Example 4, except that a highly crystalline graphene was used in place of the xerogel. An electric double-layer layer capacitor B6 was produced in the same manner as in Comparative Example 4 except for using the slurry, and evaluated as above.

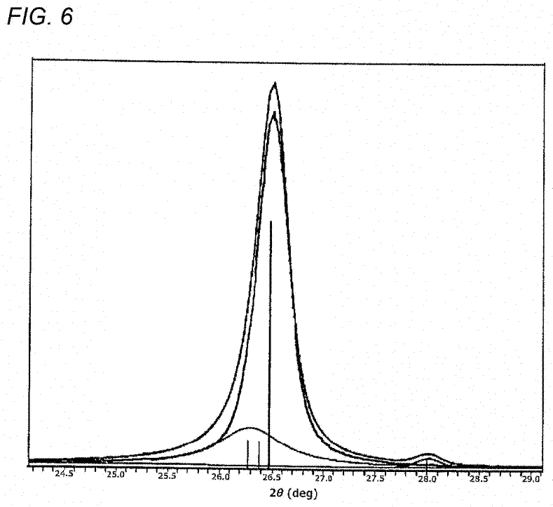

The highly crystalline graphene is the same material as used in Comparative Example 3. As shown in FIG. 3, the highly crystalline graphene is in the form of a flat sheet, and has no three-dimensional structure, such as raised and recessed portions. In FIG. 6, the peak P1 attributed to 002 plane is extremely sharp, and no halo pattern on the higher angle side is observed. The d002 of the highly crystalline graphene was 3.369 Å.

The evaluation results of the above Example 2 and Comparative Examples 4 to 6 are summarized in Table 2.

TABLE 2

| | | Capac- | |
|---|---|---|---|
| | | itance | |
| Capac- | | (F/g) at | d002 |
| itor | Electrode | 25° C. | (Å) |
| A2 | First carbon/Porous body Composite | 191 | 3.422 |
| B4 | Xerogel was formed into a slurry | 73 | — |
| | and packed in a porous body. | | |
| B5 | Activated carbon was formed into a | 161 | — |
| | slurry and packed in a porous body. | | |
| B6 | Highly crystalline graphene | 82 | 3.369 |
| | was formed into a slurry and | | |
| | packed in a porous body. | | |

As shown above, the capacitor A2 of Example 2 developed a considerably high capacitance as compared to that of the capacitor B6 produced using a highly crystalline graphene, and had a higher capacitance than that of the capacitor B5 produced using an activated carbon having a large surface area. On the other hand, in the capacitor B4 produced by forming the xerogel into a slurry, the capacitance was lower than that of the capacitor B6. This is presumably because the three-dimensional structure of the graphene collapsed in the process of forming the xerogel into a slurry.

### INDUSTRIAL APPLICABILITY

According to the present invention, an electric double-layer capacitor having a high capacitance and exhibiting a low resistance even at low temperatures can be obtained. In addition, according to the present invention, a high-capacitance capacitor electrode can be stably obtained.

### REFERENCE SIGNS LIST

1: capacitor element, 2: first electrode, 3: second electrode, 4: separator, 5a: first lead wire, 5b: second lead wire, 6: outer case, 7: sealing member, 10: electric double-layer capacitor

1. A capacitor electrode, comprising:
a first carbon; and
at least one of a second carbon other than the first carbon, and a metal porous body, wherein
the first carbon includes a graphene,
the second carbon includes short carbon fibers having an average length of 10 μm or less and/or carbon particles having an average diameter of 0.1 μm or less, and
the graphene is layered via the second carbon.

2. The capacitor electrode according to claim 1, wherein the graphene has a three-dimensional structure.

3. The capacitor electrode according to claim 1, wherein an average number of stacked layers of graphene sheets in the graphene is 10 layers or less.

4. The capacitor electrode according to claim 1, wherein an interlayer distance of graphene sheets in the graphene is varied randomly.

5. The capacitor electrode according to claim 1, wherein the graphene has a curly structure or a folded structure.

6. The capacitor electrode according to claim 1, wherein an X-ray diffraction profile of the first carbon has a diffraction peak P1 attributed to 002 plane, and has a halo pattern attributed to amorphous phase, the halo pattern observed on a higher angle side than the diffraction peak P1.

7. The capacitor electrode according to claim 6, wherein an interplanar distance of 002 planes of the first carbon as calculated from the X-ray diffraction profile is 0.338 nm or more.

8. The capacitor electrode according to claim 1, wherein the first carbon is filled in voids of the metal porous body.

9. The capacitor electrode according to claim 1, wherein the metal porous body has a three-dimensional network structure.

10. A capacitor, comprising the capacitor electrode of claim 1.

11. A method for producing a capacitor electrode, the method comprising steps of:
preparing an aqueous dispersion containing a first carbon raw material and a second carbon, the first carbon raw material being a graphene oxide; and
reducing the graphene oxide in the aqueous dispersion, wherein
the second carbon includes short carbon fibers having an average length of 10 μm or less and/or carbon particles having an average diameter of 0.1 μm or less.

12. The method for producing a capacitor electrode according to claim 11, wherein the step of reducing the graphene oxide includes obtaining a gel-form product by a hydrothermal treatment of heating the aqueous dispersion at a temperature of 150° C. or higher.

13. The method for producing a capacitor electrode according to claim 12, wherein the step of reducing the graphene oxide further includes bringing the gel-form product into contact with a reducing agent.

14. The method for producing a capacitor electrode according to claim 12, further comprising a step of freeze-drying the gel-form product.

15. A method for producing a capacitor electrode, the method comprising steps of:
preparing an aqueous dispersion containing a first carbon raw material being a graphene oxide; and
impregnating the aqueous dispersion into a metal porous body, to reduce the graphene oxide within voids of the metal porous body.

16. The method for producing a capacitor electrode according to claim 15, wherein the step of reducing the graphene oxide includes subjecting the metal porous body impregnated with the aqueous dispersion to a hydrothermal treatment, to form a gel-form product within the voids of the metal porous body.

17. The method for producing a capacitor electrode according to claim 16, wherein the step of reducing the graphene oxide further includes bringing the gel-form product into contact with a reducing agent.

18. The method for producing a capacitor electrode according to claim 16, further comprising a step of freeze-drying the gel-form product within the voids of the metal porous body.

19. The method for producing a capacitor electrode according to claim 15, wherein
the aqueous dispersion further includes a second carbon, and
the second carbon includes short carbon fibers having an average length of 10 μm or less and/or carbon particles having an average diameter of 0.1 μm or less.
